(19) United States
(12) Patent Application Publication
(10) Pub. No.: US 2005/0052535 A1
(43) Pub. Date: Mar. 10, 2005

(54) Context sensitive camera

(76) Inventor: Youssef Hamadi, Cambridge (GB)

Correspondence Address: LEE & HAYES PLLC, 421 W RIVERSIDE AVENUE SUITE 500, SPOKANE, WA, 99201, US

(21) Appl. No.: 10/659,121

(22) Filed: Sep. 10, 2003

(51) Int. Cl. H04N 5/225

(52) U.S. Cl. 348/207.11; 348/231.6

(57) ABSTRACT

Image understanding applications are assisted by a system that provides context for captured images. Devices in an image are capable of identifying themselves to the image capture device. The identifications may then be used to identify specific models needed to match possible devices in the image. In addition, the identifications may also be used to narrow the library of models needed to match possible devices in the image. Therefore, the library of possible objects may be narrowed to exclude most outdoor-oriented models or to include predominantly office-related objects. Narrowing the scope of possible models to consider can dramatically improve the effectiveness and efficiency of image understanding applications in these environments.

### TECHNICAL FIELD

The invention relates generally to image understanding, and more particularly to context sensitive camera_systems.

### DESCRIPTION

“Image understanding” refers to identifying objects in still or moving images. For example, military technologies have long been directed toward identifying buildings, planes, ships, artillery, etc. in images captured by satellites or spy planes. In other applications, image understanding is useful in annotating images with contextual information for the purpose of supporting indexing and searching of image databases. For example, images on the Web may be indexed on the basis of rich contextual information to support powerful image searching applications—e.g., searching for images containing a “Sony DCR-TRV20 Handycam”. Typically, such contextual information is provided in association with the image through manual identification of objects in the image. Other applications in which image understanding is useful include without limitation vehicle routing, industrial inspections, medical analysis, and surveillance.

In many image understanding applications, identification of objects in an image is accomplished by way of two dimensional (2D) and three dimensional (3D) modeling techniques, in which an image is compared with models of possible objects in the image. When such comparisons result in a “good” match between a model and the image, the object associated with the model is deemed to be present in the image. For example, if a model of a particular model of battleship results in a good match with a portion of an image, that portion of the image is deemed to include that type of battleship.

The effectiveness and efficiency of such applications are generally dependent upon the availability of appropriate models for objects in the image, the size of the model library, and the matching technology. However, existing approaches require significant computing resources to ensure acceptable matching accuracy over all possible models, in large part because the scope of possible objects in a generic image requires such a large library of models.

Implementations described and claimed herein enhance the effectiveness and efficiency of image understanding applications by providing context for images. In one implementation, objects in the image are capable of identifying themselves to the image capture device. The identifications may then be used to identify specific models needed to match possible objects in the image. For example, the identification of a particular model of video camera indicates that a specific model for that type of camera should be used in the evaluating the image. In addition, the identifications may also be used to narrow the library of models needed to match possible objects in the image. For example, identification of a desktop computer, a desk telephone, and a fax machine can suggest an office setting. Therefore, the library of possible objects may be narrowed to exclude most outdoor-oriented models or to include predominantly office-related objects. Narrowing the scope of possible models to consider can dramatically improve the effectiveness and efficiency of image understanding applications in these environments.

In various implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program.

The computer program product encodes a computer program for executing on a computer system a computer process that requests identification of one or more objects in association with a capture of an image. An identifier is received, responsive to the requesting operation. The identifier identifies an object in the image.

In another implementation, a method is provided. Identification of one or more objects is requested in association with a capture of an image. An identifier is received, responsive to the requesting operation. The identifier identifies an object in the image.

In yet another implementation, a system is provided that includes a signaling module coupled to a digital capture device. The signaling module requests identification of one or more objects in association with a capture of an image. The signaling module receives an identifier identifying an object in the image, responsive to requesting identification.

In yet another implementation, a computer program product encodes a computer program for executing on a computer system a computer process that receives a request for identification from an image capture device. Identification information associated with an active object is collected and transmitted from the active object to the image capture device.

In yet another implementation, a method is provided that receives a request for identification from an image capture device. Identification information associated with an active object is collected and transmitted from the active object to the image capture device.

In yet another embodiment, a system is provided that includes a detection module of an active object that receives a request for identification from an image capture device. A collection module of the active object collects identification information associated with the active object. A transmission module of the active object transmits the identification information to the image capture device.

Other implementations are also described and recited herein.

Brief descriptions of the drawings included herein are listed below.

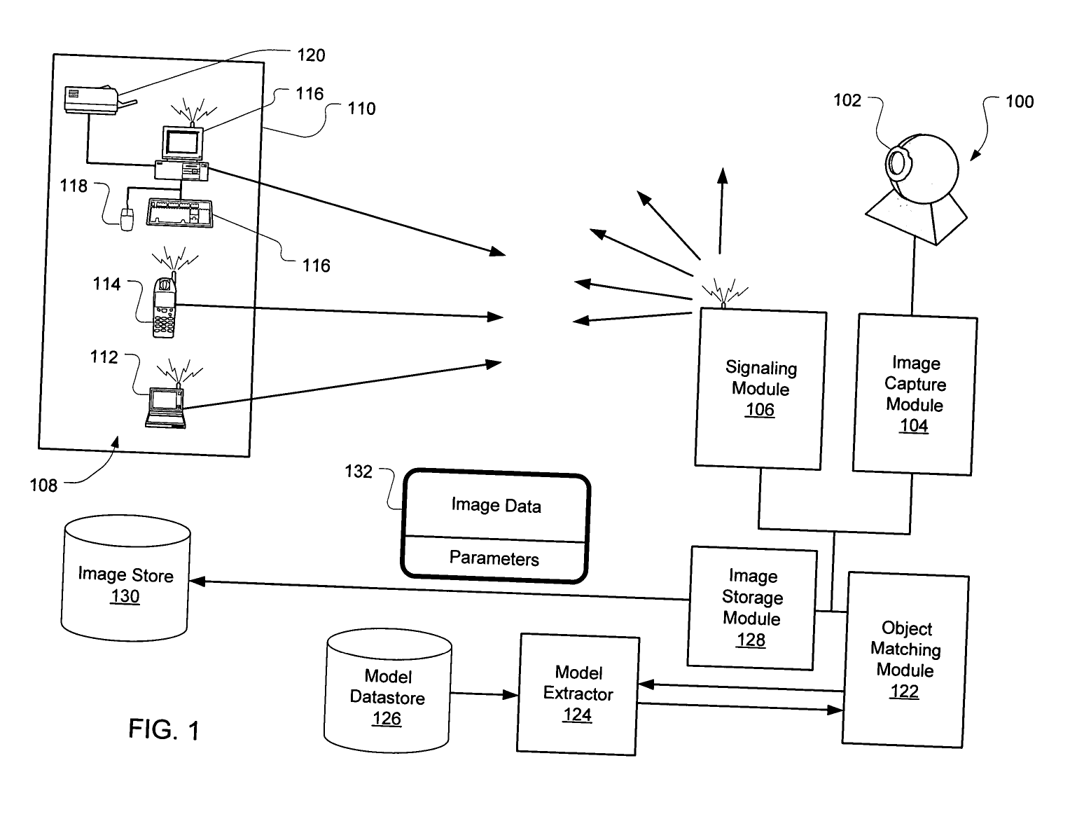

FIG. 1 illustrates an exemplary context sensitive camera system.

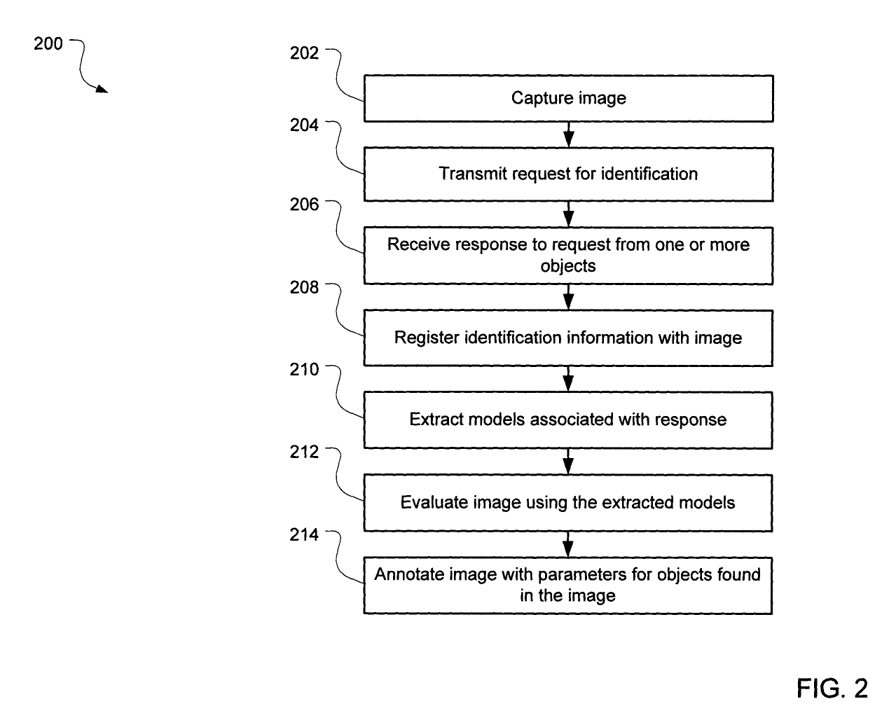

FIG. 2 illustrates exemplary operations for capturing an image with context information.

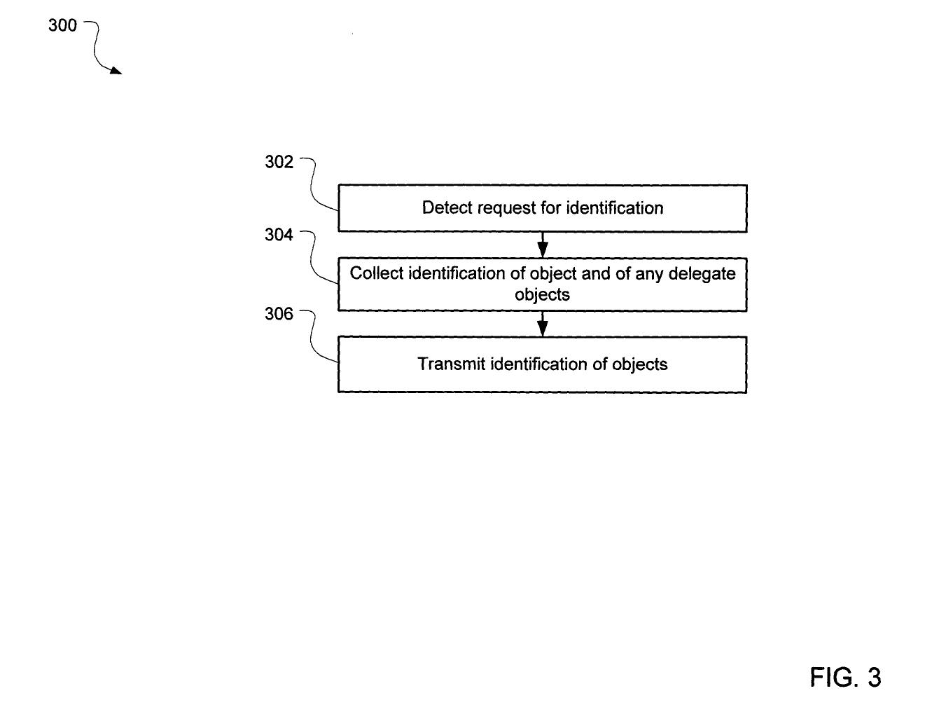

FIG. 3 illustrates exemplary operations for identifying an object to a context sensitive camera.

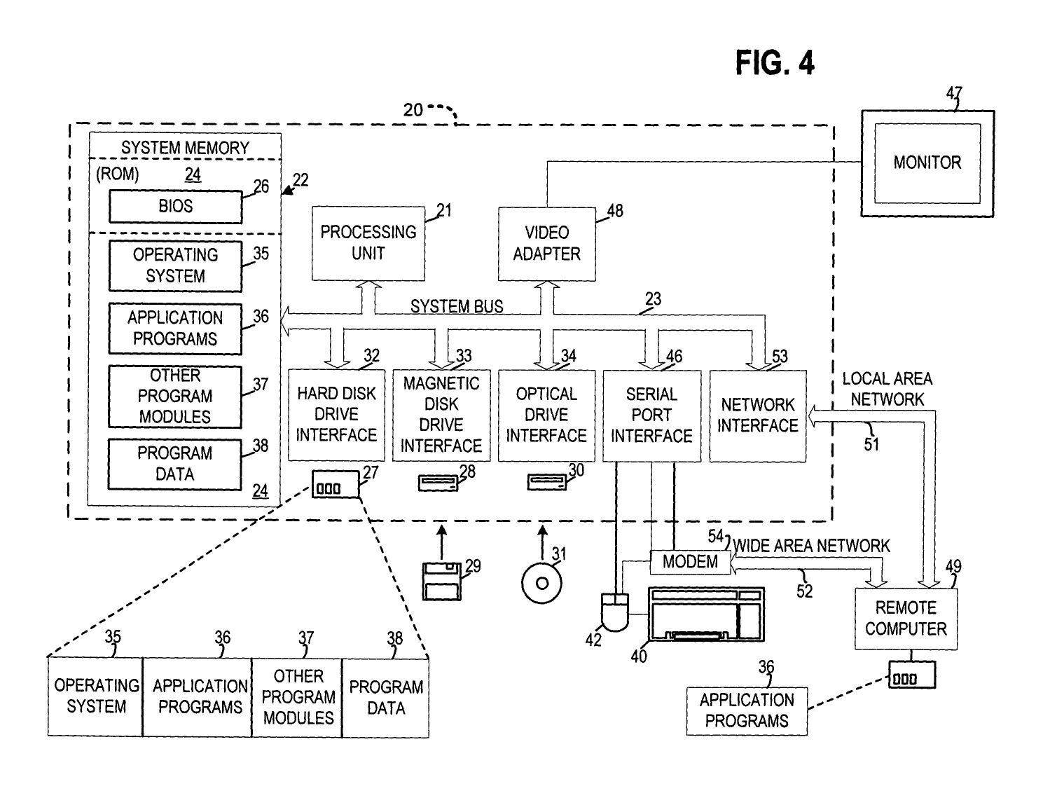

FIG. 4 illustrates an exemplary system useful for implementing an embodiment of the present invention.

In one implementation, a communications protocol is established between image capture devices (e.g., still cameras, video cameras, infrared sensors, etc.) and objects that may be in an environment. Such objects can therefore respond to requests for identification by the image capture device, even though the responding object may be outside the image capture frame (e.g., behind the camera).

In addition, in some implementations, such objects may also include objects that “respond” by delegation. For example, if one object is a desktop computer, the desktop computer may also know that it is connected to a keyboard, a mouse and a printer, and possibly the models, locations, and configurations of those connected devices. These devices may not inherently have the ability to respond to a request for identification. Therefore, the desktop computer may communicate to the image capture device what it knows about these connected objects

FIG. 1 illustrates an exemplary context sensitive camera system 100. An image capture device 102, such as a still camera, a video camera, etc., is coupled to an image capture module 104, which processes an image captured by the image capture device 102. It should be understood that the coupling between components of the system 100 may be accomplished by wired connections, wireless connections (e.g., radio frequency or infrared), or by storage and transfer (e.g., capturing an image into a flash memory and downloading the image into the image capture module or one of the other modules). The image capture module 104 controls the triggering of the image capture device 102 and receipt of the captured image. It should also be understood that the image capture device 102 may capture moving images. Therefore image capture events may be periodic or continuous.

In association with the image capture, a signaling module 106 transmits one or more identification requests to objects in the environment. In one implementation, such transmission may employ various wireless communications protocols, such as Bluetooth, GSM, GPRM, GPRS and the various versions of 802.11. However, in other implementations, infrared communications, various wired communications, and other communication means may be employed.

In various implementations, request triggers may occur periodically or may be manually or automatically initiated on a non-periodic schedule. For example, requests may be transmitted after a certain number of frames. Alternatively, the requests may be triggered when a scene changes so significantly that the videographer wants a new identification performed. In this manner, the objects identified in a video sequence can change as the scene changes.

Objects 108 in the environment 110 receive the request and collect identification information for themselves and their delegate objects. In one implementation, identification information is communicated to the signaling module 106 in an identification message and may include identifiers (IDs) of the objects as well as parameters describing the objects, their locations, or their configurations. For example, a laptop object 112 may identify itself as a “Dell C400” (or some ID representing a “Dell C400” or comparable model). In addition, the laptop object 112 may also provide identification information relating to its location in a building or in a room. Such location information may also be geographical in nature (e.g., in a specified city or country). Other identification information may specify the configuration of the laptop object 112, including whether it is opened or closed, whether it is in a docking station, etc. A cellphone object 114 capable of responding is also shown in environment 110.

A desktop computer object 116 illustrates couplings to delegate objects, including a keyboard 118, a mouse 118, and a printer 120. In some implementations, identification information for such delegate objects may be included as configuration information in the identification information returned by the desktop computer object 116. In alternative implementations, however, the identification information for such delegate objects may be transmitted by the desktop computer object 116 in individual information messages for each delegate object or in one or more group information messages for multiple delegate objects.

The desktop computer object 116 may also maintain identification information for the delegate objects in a datastore (not shown) and/or may dynamically determine identification information for those delegate objects in the vicinity in response to the request of the signaling module 106. For example, the desktop computer object 116 may record identification information for objects attached to it as such objects are installed and connected. Alternatively, the desktop computer object 116 may query devices attached to it in response the request, such as by querying devices on a peripheral bus or through an infrared communication.

After the signaling module 106 receives the identification message or messages from the objects in the environment 110, the identification information is received by an object matching module 122. In one embodiment, the identification information may, at this point, be stored in association with the image. Evaluating the image and the identification information for the purposes of accurate image understanding can take place later, or not at all, depending on the needs of the user. For example, it may be enough to know that the image was taken in the proximity of the object, whether or not the object was actually captured in the image.

In another implementation, the image data captured by the image capture module 104 is also received by the object matching module 122. The object matching module 122 sends the identification information to a model extractor 124, which uses the identification information to extract models for identified objects or for objects associated with identified objects from a model datastore 126. For example, objects relating to an indoor scene may cause exterior models to be excluded from those returned to the object matching module 122. The model datastore 126 may include various types of models, including two dimensional models and three dimensional models. In addition, the model extractor 124 may also parameterize the models to specialize them. For example, the model for the laptop object 112 may be parameterized to match a closed laptop device as opposed to an open laptop device.

Likewise, the other parameters that may be used to narrow the model set may be received to a sub-portion of possible models for a given identification. For example, based on identification of a computer, parameters identifying the object as a “Dell”-branded computer can specify that only Dell-appropriate models should be used, rather than using a generic set of models for all computers. In one implementation, by determining that the computer is a Dell system may allow the object matching module 126 to access the Dell-appropriate models directly or indirectly from the vendor (e.g., a Dell website or database).

Furthermore, a hierarchy of models may be used, wherein knowing that the object is a Dell computer, a base model for a laptop may be used to roughly identify the object as a Dell laptop computer. Thereafter, more specialized models for each specific type/configuration of Dell laptop computer may be used to further refine the identification. In this manner, identification through image understanding may be provided at various levels of detail.

The object matching module 122 matches the extracted models to objects responding to the request. However, some objects that are not actually in the image may have responded to the request. For example, some responding objects may be positioned behind the image capture device or otherwise out of frame. Therefore, the object matching module 122 attempts to determine which objects are actually in the image by evaluating the image data against the models and generates parameters identifying and/or describing the objects in the image (e.g., using keywords, reference numbers, etc.).

An image storage module 128 receives the image data and parameters identifying the matched objects and stores the parameters in association with the image data in an image store 130. For example, as shown in data 132, the parameters may be combined in a single file or data object. In contrast, the image data and the parameters may be stored in a database with associations between them. Other associated storage schemes are also contemplated. Furthermore, in the case of video images, the multiple sets of parameters may be stored at offsets within the video image file to provide accurate identification information for different scenes.

FIG. 2 illustrates exemplary operations 200 for capturing an image with context information. A capture operation 202 captures an image, such as by digital imaging or photographic techniques. A transmission operation 204 transmits a request for identification to objects in the environment. It should be understood that operations 202 and 204 may be reversed in order or may occur concurrently. Objects capable of responding to the request do so, and the responsive identification information is received by a receiving operation 206. Again, in one implementation, storing the received identification information in association with the image is useful, even without the image understanding operations. Therefore, a storage operation following the receiving operation 206 may be employed before terminating the process.

In another implementation, the exemplary process continues with a registration operation 208 that associates the received identification information with the image data. In one implementation, the digital image data and the identification information are associatively stored in temporary storage. However, in the case of photographic images, some manner of cross-referencing between a film negative and the identification information may be employed (e.g., a database associating file indices with the identification information for each image).

An extraction operation 210 extracts relevant models from a model datastore. In one implementation, the extraction operation 210 extracts models for objects identified in the identification information. In addition, groups of models may be extracted from the model datastore, thus narrowing the number of models required by an object matching operation 212. For example, based on the identification information, a sub-portion of indoor models may be extracted whereas outdoor models may be excluded. This improves the efficiency and effectiveness of object identification.

The object matching operation 212 evaluates the image using the extracted models and generates parameters for the objects identified in the image. An annotation operation 214 associatively stored the parameters with the image.

FIG. 3 illustrates exemplary operations 300 for identifying an object to a context sensitive camera. A detection operation 302 detects a request for identification of the object. For example, a cell phone may detect the request over a GSM channel or a laptop computer may detect the request over a WiFi channel.

A collection operation 304 collects identification information of the object and that of other objects of which it is aware. For example, the responding object may be aware of other attached devices or devices in its proximity and can respond with identification information for those devices as well. Alternatively or additionally, the object may query other devices to learn what objects are in the proximity. The identification information for these objects are collected in the collection operation 304 and transmitted to the image capture system in a transmitting operation 306.

The exemplary hardware and operating environment of FIG. 4 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 4. The logical connections depicted in FIG. 4 include a local-area network (LAN) 51 and a wide-area network (WAN) 52. Such networking environments are commonplace in office networks, enterprise-wide computer networks, intranets and the Internal, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an exemplary implementation, a signaling module, an image capture module, a registration module, a model extractor, and an object matching module, and other modules may be incorporated as part of the operating system 35, application programs 36, or other program modules 37. The object identifiers, the parameters, and the image data may be stored as program data 38.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

1. A method comprising:
requesting identification of one or more objects in association with a capture of an image; and
receiving an identifier, responsive to the requesting operation, the identifier identifying an object in the image.

2. The method of claim 1 wherein at least one of the objects is an active object, and the identifier of the active object is received from the active object.

3. The method of claim 1 wherein at least one of the objects is a delegate object, and the identifier of the delegate object is received from another object.

4. The method of claim 1 further comprising:
capturing the image, wherein an image capture device performs the requesting, receiving, and capturing operations.

5. The method of claim 1 further comprising:
associating the identifier with the image.

6. The method of claim 1 further comprising:
extracting a model associated with the identifier from a model library.

7. The method of claim 1 further comprising:
extracting a model associated with the identifier from a model library; and
evaluating the image using the model to determine whether the object is in the image.

8. The method of claim 1 further comprising:
identifying a sub-portion of a model library based on the identifier.

9. The method of claim 1 further comprising:
identifying a sub-portion of a model library based on the identifier; and
evaluating the image using a plurality of models in the sub-portion of the model library to identify objects in the image.

10. The method of claim 1 further comprising:
associatively storing with the image one or more parameters relating to the object identified in the image.

11. A computer program product encoding a computer program for executing on a computer system a computer process, the computer process comprising:
requesting identification of one or more objects in association with a capture of an image; and
receiving an identifier, responsive to the requesting operation, the identifier identifying an object in the image.

12. The computer program product of claim 11 wherein at least one of the objects is an active object, and the identifier of the active object is received from the active object.

13. The computer program product of claim 11 wherein at least one of the objects is a delegate object, and the identifier of the delegate object is received from another object.

14. The computer program product of claim 11 wherein the computer process further comprises:
capturing the image, wherein an image capture device performs the requesting, receiving, and capturing operations.

15. The computer program product of claim 11 wherein the computer process further comprises:
associating the identifier with the image.

16. The computer program product of claim 11 wherein the computer process further comprises:
extracting a model associated with the identifier from a model library.

17. The computer program product of claim 11 wherein the computer process further comprises:
extracting a model associated with the identifier from a model library; and
evaluating the image using the model to determine whether the object is in the image.

18. The computer program product of claim 11 wherein the computer process further comprises:
identifying a sub-portion of a model library based on the identifier.

19. The computer program product of claim 11 wherein the computer process further comprises:
identifying a sub-portion of a model library based on the identifier; and
evaluating the image using a plurality of models in the sub-portion of the model library to identify objects in the image.

20. The computer program product of claim 11 wherein the computer process further comprises:
associatively storing with the image one or more parameters relating to the object identified in the image.

21. A system comprising:
a signaling module coupled to a digital capture device requesting identification of one or more objects in association with a capture of an image; the signaling module further receiving an identifier identifying an object in the image, responsive to requesting identification.

22. The system of claim 21 wherein at least one of the objects is an active object, and the identifier of the active object is received from the active object.

23. The system of claim 21 wherein at least one of the objects is a delegate object, and the identifier of the delegate object is received from another object.

24. The system of claim 21 further comprising:
an image capture module capturing the image.

25. The system of claim 21 further comprising:
a registration module associating the identifier with the image.

26. The system of claim 21 further comprising:
a model extractor extracting a model associated with the identifier from a model library.

27. The system of claim 21 further comprising:
a model extractor extracting a model associated with the identifier from a model library; and
an object matching module evaluating the image using the model to determine whether the object is in the image.

28. The system of claim 21 further comprising:
a model extractor identifying a sub-portion of a model library based on the identifier.

29. The system of claim 21 further comprising:
a model extractor identifying a sub-portion of a model library based on the identifier; and
an object matching module evaluating the image using a plurality of models in the sub-portion of the model library to identify objects in the image.

30. The system of claim 21 further comprising:
an image storage module associatively storing with the image one or more parameters relating to the object identified in the image.

31. A method comprising:
receiving a request for identification from an image capture device;
collecting identification information associated with an active object; and
transmitting the identification information from the active object to the image capture device.

32. The method of claim 31 further comprising:
collecting identification information associated with a delegate object of the active object; and
transmitting the identification information associated with the delegate object from the active object to the image capture device.

33. A computer program product encoding a computer program for executing on a computer system a computer process, the computer process comprising:
receiving a request for identification from an image capture device;
collecting identification information associated with an active object; and
transmitting the identification information from the active object to the image capture device.

34. The computer program product of claim 33 wherein the computer process further comprises:
collecting identification information associated with a delegate object of the active object; and
transmitting the identification information associated with the delegate object from the active object to the image capture device.

35. A system comprising:
a detection module of an active object that receives a request for identification from an image capture device;
a collection module of the active object that collects identification information associated with the active object; and
a transmission module of the active object that transmits the identification information to the image capture device.

36. The system of claim 35 wherein the collection module further collects identification information associated with a delegate object of the active object and transmitting the identification information associated with the delegate object from the active object to the image capture device.
